(19) United States
(12) Patent Application Publication
(10) Pub. No.: US 2026/0132025 A1
(43) Pub. Date: May 14, 2026

(54) SULFUR PASSIVATION FOR ELECTRICALLY HEATED CATALYSIS

(71) Applicant: TOPSOE A/S, Kgs. Lyngby (DK)

(72) Inventors: Sebastian Thor WISMANN, Allerød (DK); Peter Mølgaard MORTENSEN, Roskilde (DK); Martin ØSTBERG, Tune (DK)

(73) Assignee: TOPSOE A/S, Kgs. Lyngby (DK)

(21) Appl. No.: 19/119,340

(22) PCT Filed: Oct. 30, 2023
(86) PCT No.: PCT/EP2023/080187

§ 371 Date: Apr. 8, 2025

(30) Foreign Application Priority Data
Nov. 2, 2022 (EP) 22205077.5

(51) Int. Cl. C01B 3/384; B01J 8/02; C01B 3/16

(52) U.S. Cl. CPC C01B 3/384; B01J 8/0285; C01B 3/16; B01J 2208/00176; B01J 2208/00256; B01J 2208/00398; B01J 2208/00415; B01J 2208/00884; C01B 2203/0233; C01B 2203/0283; C01B 2203/085; C01B 2203/1241; C01B 2203/1258; C01B 2203/1276

(57) ABSTRACT

A process and reactor system are provided for production of a CO-containing stream. The process includes the steps of supplying a carbon-containing first feed and an optional co-feed to the electrically-heated reactor and allowing them to undergo a CO-forming reaction, while heating the electrically-heated reactor by means of electrical power; and outletting a CO-containing stream from electrically-heated reactor, wherein the content of sulfur-containing species in the total gas mixture supplied to the electrically-heated reactor—measured in terms of H₂S—is in the range of 1-50 ppm.

### TECHNICAL FIELD

The present invention relates to a system and a process for production of a CO-containing stream, said reactor system comprising: an electrically-heated reactor; a carbon-containing first feed to said electrically-heated reactor; and a co-feed comprising sulfur-containing species to said electrically-heated reactor. A self-regulating system/process is thereby obtained, in which the severity of sulfur-absorption onto the catalyst bed of the reactor can be reduced.

### BACKGROUND

Synthesis gas is a fundamental intermediate for most chemical industry, generally reforming natural gas and steam to CO and hydrogen via the endothermic steam methane reforming reaction (SMR). Alternatively, synthesis gas can be produced by reverse water-gas-shift (RWGS) from CO₂ and excess hydrogen.

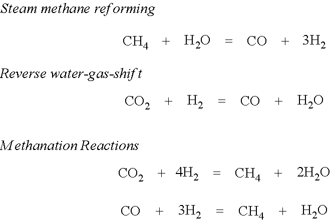

It is critical to avoid formation of carbon detrimental to catalyst activity and lifetime. For a typical industrial reformer carbon can for example be formed via one of the following mechanisms:

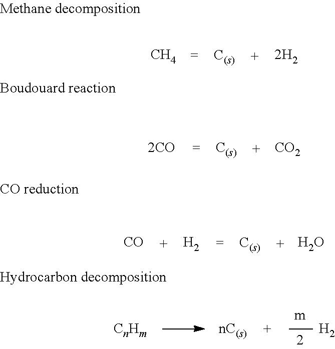

Typically, industrial reforming utilizes a nickel type catalyst, and suppression of carbon formation is achieved by operating at a sufficiently high steam-to-carbon ratio (S/C) to reduce the thermodynamic carbon activity. However, this increases the energy consumption for the overall reaction. Noble metal catalysts have a higher resistance towards carbon formation, but substantially increase cost. The amount of absorbed sulfur is dependent on the concentration in the feed and the temperature of the catalyst. Sulfur concentrations exceeding a few ppm will severely deactivate a conventional reforming catalyst, where regeneration typically is not feasible, demanding replacement of the catalyst and more rigorous cleaning of the feed gas.

Alternatively, the sulfur passivated reforming process (SPARG) use small amounts of sulfur to block the most active catalytic sites, which inhibits carbon formation but at the same time reduces catalytic activity. Once sulfur has been adsorbed on the catalyst desorption of sulfur is not possible. A conventional Sulfur Passivated Reforming (SPARG) process can inhibit carbon potential but has a severe impact on catalytic activity. Sulfur is generally detrimental to the reformer catalyst, which eventually demands replacing the catalyst loading or catalyst material when the sulfur capacity is reached.

WO2019228797A1 discloses a reactor system and a process for carrying out steam reforming of a feed gas comprising hydrocarbons, where the heat for the endothermic reaction is provided by resistance heating.

It would be advantageous to provide a system and process for production of a CO-containing stream, particularly a syngas stream, in which carbon formation and decomposition can be inhibited. Another object is to provide a system and process which is more tolerant to sulfur impurities in the feed. Yet another object is to provide a system and process which is self-regulating, and will e.g., automatically reduce severity in case of sulfur exposure.

### SUMMARY

In a first aspect the present invention relates to a process for production of a CO-containing stream from a carbon-containing first feed in a reactor system of the invention, optionally in the presence of a co-feed comprising sulfur-containing species; said reactor system comprising:
an electrically-heated reactor (10) comprising a catalyst capable of converting a carbon-containing first feed into the CO-containing stream;
a carbon-containing first feed (1) to said electrically-heated reactor;
optionally a co-feed comprising sulfur-containing species (2) to said electrically-heated reactor;
   said process comprising the steps of
supplying said carbon-containing first feed (1) and said co-feed (2), if present, to the electrically-heated reactor (10) and allowing them to undergo a CO-forming reaction, while heating said electrically-heated reactor by means of electrical power; and
outletting a CO-containing stream from electrically-heated reactor,
   wherein the content of sulfur-containing species in the total gas mixture supplied to the electrically-heated reactor—measured in terms of H₂S—is in the range of 1-50 ppm.

The present invention further relates to a reactor system for carrying out the process of the invention for production of a CO-containing stream (11), said reactor system comprising:
an electrically-heated reactor (10) comprising a catalyst capable of converting a carbon-containing first feed into the CO-containing stream;
a carbon-containing first feed (1) to said electrically-heated reactor;
optionally a co-feed comprising sulfur-containing species (2) to said electrically-heated reactor;
   wherein the content of sulfur-containing species in the total gas mixture supplied to the electrically-heated reactor—measured in terms of H₂S—is in the range of 1-50 ppm.

A chemical plant is also provided which comprises the reactor system of the invention, and a heat exchange reformer or a feed-effluent heat exchanger, wherein the CO-containing stream from the reactor system is arranged to be fed to the heat exchange reformer or the feed-effluent heat exchanger.

Further details of the technology are provided in the enclosed dependent claims, figures and examples.

### LEGENDS

The technology is illustrated by means of the following illustrations, in which:

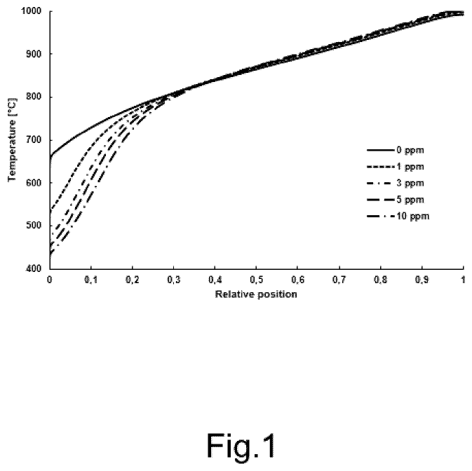

FIG. 1 shows modelled temperature for the RWGS reaction as a function of axial position on the catalyst surface.

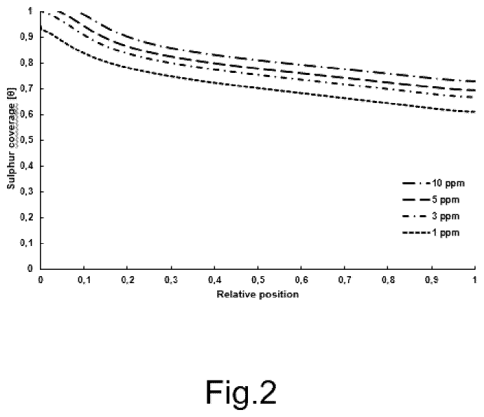

FIG. 2 shows sulfur coverage for the RWGS reaction as a function of axial position on the catalyst surface.

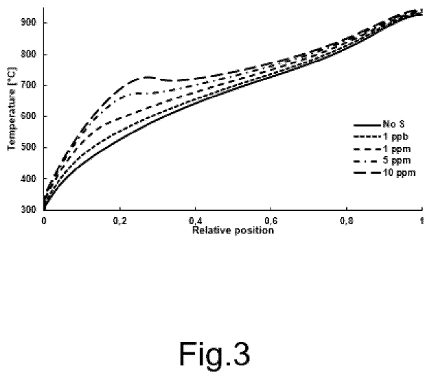

FIG. 3 shows modelled temperature for the SMR reaction as a function of axial position on the catalyst surface.

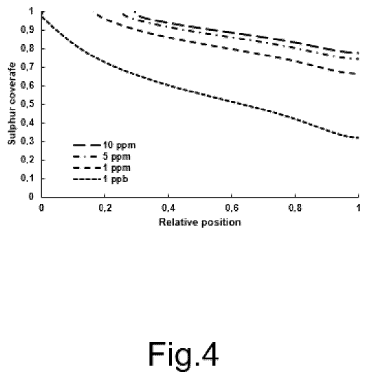

FIG. 4 shows sulfur coverage for the SMR reaction as a function of axial position on the catalyst surface.

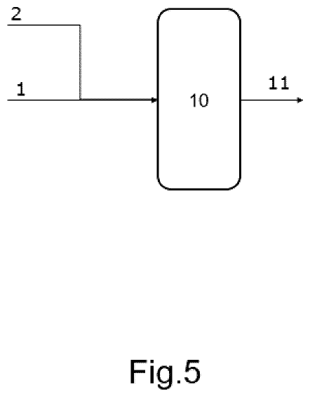

FIG. 5 shows a schematic layout of the system of the invention.

### DETAILED DISCLOSURE

Unless otherwise specified, any given percentages for gas content are % by volume. All feeds are preheated as required.

The present inventors have discovered that sulfur passivation of electrically heated catalyzed hardware can inhibit carbon formation similar to a conventional Sulfur Passivated Reforming (SPARG) process, but unexpectedly with a significantly reduced negative impact on catalyst activity, due to auto-regeneration enabled by integrated ohmic/resistance heating. The reduced negative impact on catalyst activity also increases the threshold for operation with a higher concentration of sulfur impurities in the feed compared to conventional fired processes.

By using catalyzed hardware with integrated ohmic heating, the supplied heat is proportional to the resistance. The strongly endothermic SMR reaction consumes the majority of supplied heat, and consequently, a local reduction in catalyst activity, such as by sulfur passivation, will result in localized heating in the absence of consumption of heat by the reaction. This local increase in temperature desorbs some of the sulfur-containing species, reducing the severity of the sulfur absorption. This benefits three purposes; firstly, the system will automatically reduce severity in case of sulfur exposure (auto-regeneration), and secondly, the system is overall more tolerant to sulfur impurities and variations of sulfur content in the feed, and thirdly, it enables more localized sulfur passivation near the feed inlet inhibiting carbon formation by decomposition, where the problem of carbon formation is much higher than further downstream in the reformer due to high levels of methane and low levels of hydrogen in the feed, which will drive the methane decomposition reaction.

Auto-regeneration from sulfur passivation reduces the overall impact on catalyst activity, in theory enabling effective inhibition of carbon formation with minimal impact on conversion, in stark contrast to sulfur passivation for conventional reforming using catalyst pellets. Secondly, it in theory enables operation with less pure feedstocks, imposing less strain on gas-cleaning and the pre-reformer (assuming downstream processes are tolerant). Additionally, the sulfur passivated approach allows for metal dusting prevention/inhibition in downstream equipment after the reformer.

Sulfur-containing species in the feed will adsorb to the catalytic sites in the electrically-heated reactor, preferentially towards the most active, but with sufficient concentrations to all active sites, completely deactivating the catalyst. Increasing temperature will desorb sulfur towards the equilibrium concentration. Loss of catalyst activity for catalyzed hardware with integrated ohmic heating used for an endothermic process will result in local increase in temperature. In essence, this auto-regenerates the catalyst to a stage of reduce passivation severity. This substantially reduce the relative volume of the catalyst completely deactivated by sulfur compared to a fired reactor using catalyst pellets. Thus, even though the catalyst volume of an electrically heated reformer is much smaller than that of a fired reformer with a bed of catalyst pellets, is has surprisingly been shown that an electrically heated reformer will not be inactivated by SPARG due to the auto-regeneration mechanism.

A further advantage of the present invention is that the slight sulfur deactivation of the reformer will allow operation of the reactor at a significantly lower steam to carbon (S/C) ratio compared to a non-passivated operation. The ranges for the S/C ratio will depend on pressure and feed composition. For a non-passivated catalyst the S/C in the total gas mixture supplied to the electrically-heated reactor will typically be 1.3-2.5 for production of CO rich gas via SMR. With sulfur passivation it is possible to operate at S/C 0.6-1.0. A lower S/C ratio will allow for reduced energy use of the reactor as less energy is needed for bulk gas heating. This is especially attractive when producing CO rich syngas, such as syngas with H₂/CO<3.

An additional advantage of the present invention is as follows: In feed-effluent heat exchangers downstream from the reformer, which are operated at lower temperatures than the reformer, metal dusting corrosion is a problem in non-sulfur passivated systems due to the required temperature of operation during cooling of the high-temperature CO-containing stream from the electrically-heated reactor. The presence of sulfur-containing species in the gas has the further benefit that it helps reduce the risk of metal dusting in downstream and colder equipment from the reformer. Having a little sulfur in the gas opens up for integration of the reformer with heat exchange reformers, e.g. catalytic conversion on the feed side, and feed-effluent heat exchangers rather than using e.g. a boiler as in conventional processes for production of a CO-containing gas. This is because sulfur can also inhibit carbon formation in the heat exchangers. By recovering heat from the product to pre-heat the feed, less total power is required. In a simple process the heat exchangers would be placed before (feed) and after (effluent) the electrically-heated reactor. In a full scale plant there will typically be multiple heat exchangers.

### Process

A process is provided for production of a CO-containing stream from a carbon-containing first feed in a reactor system, optionally in the presence of a co-feed comprising sulfur-containing species; said reactor system comprising:
an electrically-heated reactor (10) comprising a catalyst capable of converting a carbon-containing first feed into the CO-containing stream;
a carbon-containing first feed (1) to said electrically-heated reactor;
optionally a co-feed comprising sulfur-containing species (2) to said electrically-heated reactor;
   said process comprising the steps of
supplying said carbon-containing first feed (1) and said co-feed (2), if present, to the electrically-heated reactor (10) and allowing them to undergo a CO-forming reaction, while heating said electrically-heated reactor by means of electrical power; and
outletting a CO-containing stream from electrically-heated reactor,
wherein the content of sulfur-containing species in the total gas mixture supplied to the electrically-heated reactor—measured in terms of H₂S—is in the range of 1-In a preferred embodiment of the process of the invention, the content of sulfur-containing species in the total gas mixture supplied to the electrically-heated reactor—measured in terms of H₂S—is in the range of 1-50 ppm, preferably in the range of 1-20 ppm, more preferably in the range of 1-10 ppm.

In a particular embodiment of the process of the invention, the content of sulfur-containing species in the total gas mixture supplied to the electrically-heated reactor—measured in terms of H₂S—is in the range of 1-20 ppm, more preferably in the range of 1-10 ppm.

The process produces a CO-containing stream which is preferably a synthesis gas (syngas) stream, preferably wherein the CO-containing stream additionally comprises H₂, H₂O, CO₂, CH₄ and mixtures thereof.

In one aspect, the process further comprises the step of pressurizing the combined feed upstream the inlet of the electrically-heated reactor, preferably to a pressure of between 5 and 30 bar.

The combined feed may be pressurized, upstream the inlet of the electrically-heated reactor, preferably to a pressure of between 30 and 200 bar, preferably between 80 and 180 bar.

The feed gas inlet the electrically-heated reactor suitably has a temperature between 200° C. and 700° C.

In the process according to the invention, the space velocity evaluated as flow of gas relative to the geometric surface area of the structured catalyst is suitably between 0.6 and 60 Nm³/m³/h or between 700 Nm³/m³/h and 70000 Nm³/m³/h when evaluated as flow of gas relative to the occupied volume of the structured catalyst.

### Carbon-Containing First Feed

The carbon-containing first feed is fed to the electrically-heated reactor, and converted into a CO-containing stream. The first feed may be a hydrocarbon-rich feed gas, a CO-containing feed gas, a CO₂-rich feed gas, or a feed gas comprising a mixture of hydrocarbons and CO. Preferably, the first feed is a hydrocarbon-rich feed gas. In the present context, the statement that a gas is “rich” in a particular component means that said gas contains more than 50% v/v, such as e.g. more than 75% v/v or more than 80% v/v or more than 95% v/v of said component (as dry percentages).

The selection of the first feed is dependent on the type of reaction to be carried out in the electrically-heated reactor.

When the first feed is a methane-rich feed, the primary reaction in the reactor is steam methane reforming, and the steam/hydrocarbon ratio in the first feed is preferably between 0.5-2.

When the first feed is a biogas, the reactions in the reactor are primarily methanation or steam methane reforming, and the steam/methane ratio in the first feed is preferably between 0.5-2.

When the first feed is a CO₂-rich feed, the primary reaction in the reactor is a RWGS reaction, and the H₂/CO₂ ratio in the first feed is preferably between 2-4.

In one aspect, the first feed is a hydrocarbon-rich feed gas, the electrically-heated reactor is an electrically-heated steam reforming reactor, wherein the catalyst is capable of catalyzing a steam reforming reaction and the reactor system further comprises a steam feed to the electrically-heated reactor. Suitable structure and components for an electrically-heated steam reforming reactor are described in WO2019228797A1.

In another aspect, the first feed is a CO₂-rich feed gas, wherein the electrically-heated reactor is an electrically-heated reverse water gas shift (e-RWGS) reactor, wherein the catalyst is capable of catalyzing a water gas shift reaction, and wherein said reactor system further comprises a hydrogen feed to the electrically-heated reactor. The electrically-heated reactor is an electrically-heated reverse water gas shift (e-RWGS) reactor; preferably where the e-RWGS reactor comprises a structured catalyst comprising a macroscopic structure of electrically conductive material capable of catalysing a reverse water gas shift reaction, a steam reforming reaction, and a methanation reaction, and wherein said reactor system further comprises a hydrogen feed to the electrically-heated reactor. Further details of this aspect are to be found in WO2022079098, which is hereby incorporated by reference.

In this particular aspect, the first feed is advantageously a mixed CO and CO₂ feed gas.

In a particular embodiment of the process of the invention, the first feed, prior to being supplied to the electrically-heated reactor, is subjected to a sulfur-removing step in a sulfur-removal section arranged to remove sulfur-containing species in the first feed.

The carbon-containing first feed may, before sulfur removal pretreatment, if any, prior to supplying it to the electrically-heated reactor (10), comprise a small amount of sulfur-containing species. Preferably the content of sulfur-containing species in the first feed—measured in terms of H₂S—is in the range of 1-10000 ppm, preferably in the range of 1-1000 ppm, preferably in the range of 1-100 ppm, preferably in the range of 1-50 ppm, more preferably in the range of 1-10 ppm.

In a particular embodiment of the process of the invention, the content of sulfur-containing species in the first feed is controlled such that the content of sulfur-containing species in the total gas mixture supplied to the electrically-heated reactor—measured in terms of H₂S—is in the range of 1-50 ppm, preferably in the range of 1-20 ppm, more preferably in the range of 1-10 ppm, and wherein no co-feed is supplied to the electrically-heated reactor.

### Co-Feed Comprising Sulfur-Containing Species

In a particular embodiment of the process of the invention, a co-feed comprising sulfur-containing species is supplied to the electrically-heated reactor. The co-feed may be supplied to the electrically-heated reactor as a separate stream or by mixing it with the first feed upstream the electrically-heated reactor to form a combined feed stream, and supplying the combined feed stream to the electrically-heated reactor.

The content of sulfur-containing species is controlled such that the content of sulfur-containing species in the total gas mixture supplied to the electrically-heated reactor—measured in terms of H₂S—is in the range of 1-50 ppm, preferably in the range of 1-20 ppm, more preferably in the range of 1-10 ppm (on a wet basis).

In a particular embodiment the process of the invention the first feed, prior to being supplied to the electrically-heated reactor, is subjected to a sulfur-removing step in a sulfur-removal section arranged to remove sulfur-containing species in the first feed to a level—measured in terms of H₂S—of below 1 ppm, preferably below 100 ppb, and most preferably below 10 ppb, and wherein the co-feed is supplied in an amount so that the content of sulfur-containing species in the total gas mixture supplied to the electrically-heated reactor—measured in terms of H₂S—is in the range of 1-50 ppm, preferably in the range of 1-20 ppm, more preferably in the range of 1-10 ppm.

This embodiment involves a number of advantages. Firstly, the embodiment makes it possible to use first feeds from different sources with quite different contents of sulfur before the sulfur-removing step as well as first feeds supplies, where the content of sulfur vary over time during operation. Furthermore, the embodiment makes it possible to control the exact level of sulfur in the first feed to be supplied to the electrically-heated reformer with high precision.

The sulfur-removal section may be any conventional sulfur-removal section, such as a hydrogenation reactor converting sulfur in the feed to H2S and/or an absorption reactor absorbing the H2S onto an absorbent, such as a ZnO based absorbent and a Cu-promoted ZnO based absorbent. In addition to said hydrogenation reactor and/or said absorption reactor, the sulfur-removal section may further comprise unit comprising an activated carbon material suitable for absorption of sulfur species. In addition to or in place of said hydrogenation reactor and/or said absorption reactor and said optional activated carbon unit, the sulfur-removal section may also comprise a prereformer, e.g. an adiabatic prereformer, e.g. with a Ni-based catalyst.

The term “total gas mixture” refers to the entirety of all feed gases to the reactor, including the carbon-containing first feed, the co-feed, and any additional feeds such as hydrogen, or steam.

The sulfur-containing species in the co-feed may be one or more of methylmercaptan, dimethylsulphide, sulfur dioxide or hydrogen sulfide.

The first feed and said co-feed comprising sulfur-containing species are preferably arranged to be mixed to a combined feed, prior to being supplied to the inlet of the electrically-heated reactor.

### CO-Containing Stream

The process and reactor system of the invention provide a CO-containing stream. The CO-containing stream is suitably a synthesis gas (syngas) stream, preferably wherein the CO-containing stream additionally comprises H₂, H₂O, CO₂, CH₄ and mixtures thereof.

In one aspect, the CO containing stream is a synthesis gas stream comprising components within the following ranges (in vol %):
10-25% CO
5-20% CO₂
35-65% H₂
5-30% H₂O
0.1-2.5% CH₄
0-2% N₂

Trace amounts of other gases, e.g. Ar may also be present.

In one aspect of the process of the invention, the CO-forming reaction is steam methane reforming. In another aspect of the process of the invention, the CO-forming reaction is a reverse water gas shift (RWGS) reaction.

Preferably, the reactor system and the process provide a CO-containing stream having a H2/CO—ratio between 1-4, preferably between 1.5-3, most preferably between 2-2.1.

The reactor system and process may provide a CO-containing stream having a methanol module between 1-3, preferably between 2-2.1.

Methanol module is defined as

$$\frac{{H}_{2} + {CO}_{2}}{CO + {CO}_{2}}$$

based on mole %. The ideal module is 2.

In an embodiment, the process and reactor system of the invention further comprises a sulfur-removal section arranged to receive the CO-containing stream from said electrically-heated reactor and remove sulfur-containing species from said CO-containing stream. In this manner, any sulfur-containing species are removed from the CO-containing stream, downstream the reformer, typically after temperature adjustment, and typically by absorption in a chemical absorbent. This can be done before and/or after condensation and removal of water from the product stream.

### Electrically-Heated Reactor

The reactor system of the invention comprises an electrically-heated reactor comprising a catalyst capable of converting a carbon-containing first feed into the CO-containing stream. The electrically-heated reactor may be an induction-heated reactor or a resistance-heated reactor. The electrically-heated reactor suitably comprises a structured catalyst, preferably comprising Ni, Pt, Ru, Co, Ir, Rh, Mn or mixtures of these as the catalytically active metal, wherein said structured catalyst is arranged to be electrically-heated.

### Resistance-Heated Reactors

With integrated ohmic heating, the locally supplied heat is proportional to resistance, which for the utilized alloys is independent of temperature.

Suitably the electrically-heated reactor is of a type, which has a structured catalyst, said structured catalyst comprising a macroscopic structure of electrically conductive material, said macroscopic structure supporting a ceramic coating, wherein said ceramic coating supports a catalytically active material. In one particular embodiment, the electrically-heated reactor comprises:
a structured catalyst, said structured catalyst comprising a macroscopic structure of electrically conductive material, said macroscopic structure supporting a ceramic coating, wherein said ceramic coating supports a catalytically active material;
a pressure shell housing said structured catalyst, said pressure shell comprising an inlet for letting in said feed gas and an outlet for letting out product gas, wherein said inlet is positioned so that said feed gas enters said structured catalyst in a first end of said structured catalyst and said product gas exits said structured catalyst from a second end of said structured catalyst; and
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure, wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors.

Further details of such an electrically-heated reactor are presented in WO2019228797A1, the contents of which are incorporated by reference.

In another type of electrically-heated reactor the catalytically active material, e.g. coated onto a ceramic support, may be heated by physical close contact to an electric wire arranged in a bed of catalyst, e.g. in a meandering manner. Thus, here the ceramic material is not coated onto the electrically conductive material. Here the catalyst may both be pellets and a structured catalyst. Reference is made to WO21209509 (Pauletto) and to WO2019228798.

### Induction-Heated Reactors

The electrically-heated reactor may be an induction-heated reactor. One such an induction-heated reactor is described in WO2017036794, which is hereby incorporated by reference.

Here, the reactor unit comprises a catalyst material with one or more ferromagnetic macroscopic supports susceptible to induction heating. The ferromagnetic macroscopic supports are ferromagnetic at temperatures up to an upper limit of a given temperature range T. The ferromagnetic macroscopic supports are coated with an oxide, where the oxide is impregnated with catalytically active particles. An induction coil is powered by a power source supplying alternating current and positioned so as to generate an alternating magnetic field within the reactor unit upon energization by the power source, whereby the catalyst material is heated to a temperature within said temperature range T by means of said alternating magnetic field.

Another such induction-heated reactor is described in WO2017186437 which is hereby incorporated by reference. Here, a tube heat exchange reactor comprises:
an outer tube with a first and a second end, where the first end is an inlet end and where the second end is a closed end,
an inner tube coaxially arranged within the outer tube and spaced apart from the outer tube, where at least a part of said inner tube holds a bed of catalyst material susceptible for induction heating and where said inner tube has an inlet end and an outlet end,
an induction coil placed within an annular space confined between the outer and the inner tube, and
a power source arranged to supply alternating current to the induction coil in order to generate an alternating magnetic field within at least a part of said bed of catalyst material within said inner tube,
wherein said tube heat exchange reactor is arranged to allow a process gas stream to be led into the inlet end of said outer tube, to flow in the annular space confined between the outer and inner tube towards the second end of the outer tube and subsequently into said inner tube in order to reach said bed of catalyst material and undergo an endothermic reaction resulting in a product gas.

### Specific Embodiments

FIG. 1 illustrates the temperature profile with increasing sulfur concentration in the feed gas for the RWGS reaction with all other parameters constant. RWGS on a nickel type catalyst enables methanation (reverse SMR), a strongly exothermic reaction, which has an ameliorating effect on sulfur passivation, as illustrated in FIG. 1. This is in addition to the effect of integrated ohmic heating.

FIG. 2 shows the sulfur coverage corresponding to the temperature profiles in FIG. 1.

FIG. 3 illustrates CFD simulations with increasing sulfur concentration in the feed gas under SMR conditions. Compared to the base case with no sulfur (0 ppm), the temperature increases more steeply with additional sulfur in the feed. For a concentration of 5 ppm sulfur in the feed, the point where the reaction starts is clearly visible as the endothermic reaction is balanced by the heat supply, creating a small zone with constant temperature.

FIG. 4 shows the sulfur coverage corresponding to the temperature profiles in FIG. 3.

FIG. 5 illustrates a reactor system according to the invention, including an electrically-heated reactor (10), carbon-containing first feed (1) to said electrically-heated reactor; and a co-feed comprising sulfur-containing species (2) to said electrically-heated reactor.

The present invention has been described with reference to a number of embodiments and figures. However, the skilled person is able to select and combine various embodiments within the scope of the invention, which is defined by the appended claims. All documents referenced herein are incorporated by reference.

### ASPECTS

The following aspects of the invention are provided:

Aspect 1. A process for production of a CO-containing stream from a carbon-containing first feed in a reactor system, optionally in the presence of a co-feed comprising sulfur-containing species; said reactor system comprising:
an electrically-heated reactor (10) comprising a catalyst capable of converting a carbon-containing first feed into the CO-containing stream;
a carbon-containing first feed (1) to said electrically-heated reactor;
optionally a co-feed comprising sulfur-containing species (2) to said electrically-heated reactor;
   said process comprising the steps of
supplying said carbon-containing first feed (1) and said co-feed (2), if present, to the electrically-heated reactor (10) and allowing them to undergo a CO-forming reaction, while heating said electrically-heated reactor by means of electrical power; and
outletting a CO-containing stream from electrically-heated reactor,
wherein the content of sulfur-containing species in the total gas mixture supplied to the electrically-heated reactor—measured in terms of H₂S—is in the range of 1-50 ppm

Aspect 2. The process according to aspect 1, wherein the content of sulfur-containing species in the total gas mixture supplied to the electrically-heated reactor—measured in terms of H₂S—is in the range of 1-20 ppm, more preferably in the range of 1-10 ppm.

Aspect 3. The process according to any of aspects 1-2, wherein the CO-forming reaction is steam methane reforming.

Aspect 4. The process according to any one of aspects 1-2, wherein the CO-forming reaction is a reverse water gas shift (RWGS) reaction.

Aspect 5. The process according to aspect any of the preceding aspects, wherein the reactor system provides a CO-containing stream having a H2/CO—ratio between 1-4, preferably between 1.5-3, most preferably between 2-2.1.

Aspect 6. The process according to any of the preceding aspects, wherein the reactor system provides a CO-containing stream having a methanol module between 1-3, preferably between 2-2.1.

Aspect 7. The process according to any of the preceding aspects, wherein the CO-containing stream is a synthesis gas (syngas) stream, preferably wherein the CO-containing stream additionally comprises H₂S, H₂, H₂O, CO₂, CH₄ and mixtures thereof.

Aspect 8. The process according to any of the preceding aspects, further comprising the step of pressurizing the combined feed upstream the inlet of the electrically-heated reactor, preferably to a pressure of between 5 and 30 bar.

Aspect 9. The process according to any of the preceding aspects, further comprising the step of pressurizing the combined feed upstream the inlet of the electrically-heated reactor, preferably to a pressure of between 30 and 200 bar, preferably between 80 and 180 bar.

Aspect 10. The process according to any of the preceding aspects, wherein the temperature of the feed gas inlet the electrically-heated reactor is between 200° C. and 700° C.

Aspect 11. The process according to any of the preceding aspects, wherein the space velocity evaluated as flow of gas relative to the geometric surface area of the structured catalyst is between 0.6 and 60 Nm³/m³/h or between 700 Nm³/m³/h and 70000 Nm³/m³/h when evaluated as flow of gas relative to the occupied volume of the structured catalyst.

Aspect 12. The process according to any of the preceding aspects, wherein the first feed, prior to being supplied to the electrically-heated reactor, is subjected to a sulfur-removing step in a sulfur-removal section arranged to remove sulfur-containing species in the first feed.

Aspect 13. The process according to any of the preceding aspects, wherein the carbon-containing first feed, before sulfur removal pretreatment, if any, prior to supplying it to the to the electrically-heated reactor (10), comprises sulfur-containing species, preferably wherein the content of sulfur-containing species in the first feed—measured in terms of H₂S—is in the range of 1-5000 ppb, preferably in the range of 1-1000 ppb, preferably in the range of 1-100 ppb, more preferably in the range of 1-10 ppb.

Aspect 14. The process according to any of the preceding aspects, wherein co-feed is supplied to the electrically-heated reactor (10).

Aspect 15. The process according to aspect 14, wherein the first feed, prior to being supplied to the electrically-heated reactor, is subjected to a sulfur-removing step in a sulfur-removal section arranged to remove sulfur-containing species in the first feed to a level—measured in terms of H₂S—of below 1 ppm, preferably below 100 ppb, and most preferably below 10 ppb, and wherein the co-feed is supplied in an amount so that the content of sulfur-containing species in the total gas mixture supplied to the electrically-heated reactor—measured in terms of H₂S—is in the range of 1-50 ppm, preferably in the range of 1-20 ppm, more preferably in the range of 1-10 ppm.

Aspect 16. The process according to any of aspects 1-13, wherein the content of sulfur-containing species in the first feed is controlled such that the content of sulfur-containing species in the total gas mixture supplied to the electrically-heated reactor—measured in terms of H₂S—is in the range of 1-50 ppm, preferably in the range of 1-20 ppm, more preferably in the range of 1-10 ppm, and wherein no co-feed is supplied to the electrically-heated reactor

Aspect 17. A reactor system for carrying out the process of aspect 1 for production of a CO-containing stream (11), said reactor system comprising:
an electrically-heated reactor (10) comprising a catalyst capable of converting a carbon-containing first feed into the CO-containing stream;
a carbon-containing first feed (1) to said electrically-heated reactor;
optionally a co-feed comprising sulfur-containing species (2) to said electrically-heated reactor;
   wherein the content of sulfur-containing species in the total gas mixture supplied to the electrically-heated reactor—measured in terms of H₂S—is in the range of 1-50 ppm.

Aspect 18. The reactor system according to aspect 17, wherein the reactor system comprises a co-feed, and wherein said first feed and said co-feed comprising sulfur-containing species are arranged to be mixed to a combined feed, prior to being supplied to the inlet of the electrically-heated reactor.

Aspect 19. The reactor system according to any of aspects 17-18, wherein said electrically-heated reactor is an induction-heated reactor or a resistance-heated reactor.

Aspect 20. The reactor system according to any of aspects 17-19, wherein said electrically-heated reactor comprises a structured catalyst, preferably comprising Ni, Pt, Ru, Co, Ir, Mn, Rh or mixtures of these as the catalytically active metal, wherein said structured catalyst is arranged to be electrically-heated.

Aspect 21. The reactor system according to any of aspects 17-20, wherein said electrically-heated reactor comprises:
a structured catalyst, said structured catalyst comprising a macroscopic structure of electrically conductive material, said macroscopic structure supporting a ceramic coating, wherein said ceramic coating supports a catalytically active material;
a pressure shell housing said structured catalyst, said pressure shell comprising an inlet for letting in said feed gas and an outlet for letting out product gas, wherein said inlet is positioned so that said feed gas enters said structured catalyst in a first end of said structured catalyst and said product gas exits said structured catalyst from a second end of said structured catalyst; and
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure, wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors.

Aspect 22. The reactor system according to any of aspects 17-21, wherein the first feed is a hydrocarbon-rich feed gas, a CO-containing feed gas, a CO₂-rich feed gas, or a feed gas comprising a mixture of hydrocarbons and CO.

Aspect 23. The reactor system according to any of aspects 17-22, wherein the first feed is a hydrocarbon-rich feed gas, and the electrically-heated reactor is an electrically-heated steam reforming reactor, wherein the catalyst is capable of catalyzing a steam reforming reaction, and wherein said reactor system further comprises a steam feed to the electrically-heated reactor.

Aspect 24. The reactor system according to any of aspects 17-22, wherein the first feed is a CO₂-rich feed gas, and the electrically-heated reactor is an electrically-heated water gas shift reactor, wherein the catalyst is capable of catalyzing a reverse water gas shift reaction, and wherein said reactor system further comprises a hydrogen feed to the electrically-heated reactor.

Aspect 25. The reactor system according to aspect 24, wherein the catalyst is capable of catalysing a reverse water gas shift reaction, a steam reforming reaction, and a methanation reaction.

Aspect 26. The reactor system according to any of aspects 17-25, further comprising a sulfur-removal section upstream said electrically-heated reactor, wherein said sulfur-removal section is arranged to remove sulfur-containing species from the first feed prior to it being fed to the electrically-heated reactor.

Aspect 27. The reactor system according to any of aspects 17-26, wherein the content of sulfur-containing species in the total gas mixture supplied to the electrically-heated reactor—measured in terms of H₂S—is in the range of 1-20 ppm, more preferably in the range of 1-10 ppm.

Aspect 28. The reactor system according to any of aspects 17-27, wherein the carbon-containing first feed, before sulfur removal pretreatment, if any, prior to supplying it to the electrically-heated reactor (10), comprises sulfur-containing species, comprises sulfur-containing species, preferably wherein the content of sulfur-containing species in the first feed—measured in terms of H₂S—is in the range of 1-5000 ppb, preferably in the range of 1-1000 ppb, preferably in the range of 1-100 ppb, more preferably in the range of 1-10 ppb.

Aspect 29. The reactor system according to one of aspects 17-28, wherein the CO-containing stream is a synthesis gas (syngas) stream, preferably wherein the CO-containing stream additionally comprises H₂S, H₂, H₂O, CO₂, CH₄ and mixtures thereof.

Aspect 30. The reactor system according to any of aspects 17-29, further comprising a sulfur-removal section arranged to receive the CO-containing stream from said electrically-heated reactor and remove sulfur-containing species from said CO-containing stream.

Aspect 31. A chemical plant comprising the reactor system according to any of aspects 17-30, and a heat exchange reformer or a feed-effluent heat exchanger, wherein the CO-containing stream (11) from the reactor system is arranged to be fed to the heat exchange reformer or the feed-effluent heat exchanger.

1. A process for production of a CO-containing stream from a carbon-containing first feed in a reactor system, optionally in the presence of a co-feed comprising sulfur-containing species; said reactor system comprising:
an electrically-heated reactor comprising a catalyst capable of converting a carbon-containing first feed into the CO-containing stream;
a carbon-containing first feed to said electrically-heated reactor;
optionally a co-feed comprising sulfur-containing species to said electrically-heated reactor;
said process comprising the steps of
supplying said carbon-containing first feed and said co-feed, if present, to the electrically-heated reactor and allowing them to undergo a CO-forming reaction, while heating said electrically-heated reactor by means of electrical power; and
outletting a CO-containing stream from the electrically-heated reactor,
wherein the content of sulfur-containing species in the total gas mixture supplied to the electrically-heated reactor—measured in terms of H₂S—is in the range of 1-50 ppm.

2. The process according to claim 1, wherein the content of sulfur-containing species in the total gas mixture supplied to the electrically-heated reactor—measured in terms of H₂S—is in the range of 1-20 ppm.

3. The process according to claim 1, wherein the CO-forming reaction is steam methane reforming.

4. The process according to claim 1, wherein the CO-forming reaction is a reverse water gas shift reaction.

5. The process according to claim 1, wherein the reactor system provides a CO-containing stream having a H2/CO—ratio between 1-4.

6. The process according to claim 1, wherein the reactor system provides a CO-containing stream having a methanol module between 1-3.

7. The process according to claim 1, wherein the CO-containing stream is a synthesis gas stream.

8. The process according to claim 1, wherein the carbon-containing first feed, before sulfur removal pretreatment, if any, prior to supplying it to the electrically-heated reactor, comprises sulfur-containing species.

9. The process according to claim 1, wherein a co-feed is supplied to the electrically-heated reactor.

10. The process according to claim 9, wherein the first feed, prior to being supplied to the electrically-heated reactor, is subjected to a sulfur-removing step in a sulfur-removal section arranged to remove sulfur-containing species in the first feed to a level—measured in terms of H₂S—of below 1 ppm, and wherein the co-feed is supplied in an amount so that the content of sulfur-containing species in the total gas mixture supplied to the electrically-heated reactor—measured in terms of H₂S—is in the range of 1-50 ppm.

11. The process according to claim 1, wherein the content of sulfur-containing species in the first feed is controlled such that the content of sulfur-containing species in the total gas mixture supplied to the electrically-heated reactor—measured in terms of H₂S—is in the range of 1-50 ppm, and wherein no co-feed is supplied to the electrically-heated reactor.

12. A reactor system for carrying out the process of claim 1 for production of a CO-containing stream, said reactor system comprising:
an electrically-heated reactor comprising a catalyst capable of converting a carbon-containing first feed into the CO-containing stream;
a carbon-containing first feed to said electrically-heated reactor;
optionally a co-feed comprising sulfur-containing species to said electrically-heated reactor;
wherein the content of sulfur-containing species in the total gas mixture supplied to the electrically-heated reactor—measured in terms of H₂S—is in the range of 1-50 ppm.

13. The reactor system according to claim 12, wherein said electrically-heated reactor comprises:
a structured catalyst, said structured catalyst comprising a macroscopic structure of electrically conductive material, said macroscopic structure supporting a ceramic coating, wherein said ceramic coating supports a catalytically active material;
a pressure shell housing said structured catalyst, said pressure shell comprising an inlet for letting in said feed gas and an outlet for letting out product gas, wherein said inlet is positioned so that said feed gas enters said structured catalyst in a first end of said structured catalyst and said product gas exits said structured catalyst from a second end of said structured catalyst; and
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure, wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors.

14. The reactor system according to claim 12, wherein the first feed is a hydrocarbon-rich feed gas, a CO-containing feed gas, a CO₂-rich feed gas, or a feed gas comprising a mixture of hydrocarbons and CO.

15. The reactor system according to claim 12, wherein the first feed is a hydrocarbon-rich feed gas, and the electrically-heated reactor is an electrically-heated steam reforming reactor, wherein the catalyst is capable of catalyzing a steam reforming reaction, and wherein said reactor system further comprises a steam feed to the electrically-heated reactor.

16. The reactor system according to claim 12, wherein the first feed is a CO₂-rich feed gas, and the electrically-heated reactor is an electrically-heated water gas shift reactor, wherein the catalyst is capable of catalyzing a reverse water gas shift reaction, and wherein said reactor system further comprises a hydrogen feed to the electrically-heated reactor.

17. The reactor system according to claim 12, wherein the content of sulfur-containing species in the total gas mixture supplied to the electrically-heated reactor—measured in terms of H₂S—is in the range of 1-20 ppm.

18. The reactor system according to claim 12, wherein the carbon-containing first feed, before sulfur removal pretreatment, if any, prior to supplying it to the electrically-heated reactor, comprises sulfur-containing species, comprises sulfur-containing species.

19. The reactor system according to claim 12, wherein the CO-containing stream is a synthesis gas stream.

20. The reactor system according to claim 12, further comprising a sulfur-removal section arranged to receive the CO-containing stream from said electrically-heated reactor and remove sulfur-containing species from said CO-containing stream.

21. A chemical plant comprising the reactor system according to claim 1, and a heat exchange reformer or a feed-effluent heat exchanger, wherein the CO-containing stream from the reactor system is arranged to be fed to the heat exchange reformer or the feed-effluent exchanger.
